(19) United States
(12) Patent Application Publication
(10) Pub. No.: US 2021/0232292 A1
(43) Pub. Date: Jul. 29, 2021

(54) SYSTEM AND METHOD FOR A ZOOM FUNCTION

(71) Applicant: IMINT Image Intelligence AB, UPPSALA (SE)

(72) Inventors: Bettina SELIG, Uppsala (SE); Vladimir CURIC, Uppsala (SE)

(73) Assignee: IMINT Image Intelligence AB, UPPSALA (SE)

(21) Appl. No.: 16/304,741

(22) PCT Filed: May 11, 2017
(86) PCT No.: PCT/EP2017/061348

§ 371 Date: Nov. 27, 2018

(30) Foreign Application Priority Data
May 27, 2016 (EP) 16171711.1

(51) Int. Cl. G06F 3/0484; G11B 27/031

(52) U.S. Cl. CPC G06F 3/04845; G06F 3/04883; G11B 27/031

(57) ABSTRACT

A system (100) and method for zooming of a video recording are provided. The system is configured to detect, track and select object(s) in a first view (110) of the video recording. The system further is configured to perform at least one of an in-zooming and an out-zooming of the video recording relative the first view of the video recording. The system is configured to stop a performed in-zooming or out-zooming, in case at least one predetermined event occurs during the video recording.

### FIELD OF THE INVENTION

The present invention generally relates to the field of video technology. More specifically, the present invention relates to a system for zooming in a video recording.

### BACKGROUND OF THE INVENTION

The recording of videos, especially by the use of handheld devices, is constantly gaining in popularity. It will be appreciated that a majority of today's smartphones are provided with a video recording function, and as the number of smartphone users may be in the vicinity of 3 billion in a few years' time, the market for functions and features related to video recording, especially for devices such as smartphones, is ever-increasing.

The possibility to zoom when recording a video is one example of a function which often is desirable. In case the video is recorded by a device having a touch-sensitive screen, a zoom may often be performed by the user's touch on the screen. However, manual zoom functions of this kind may suffer from several drawbacks, especially when considering that the user may often need to perform the zooming whilst being attentive to the motion of the (moving) object(s). For example, when performing a manual zoom during a video recording session, the user may be distracted by this operation such that he or she loses track of the object(s) and/or that the object(s) move(s) out of the zoomed view. Another problem of performing a manual zoom of this kind is that the user may unintentionally move the device during the zooming, which may result in a video where the one (or more) object is not rendered in a desired way in the video.

Hence, alternative solutions are of interest, which are able to provide a convenient zoom function and/or by which zoom function one or more zoomed objects may be rendered in an appealing and/or convenient way in a video recording.

### SUMMARY OF THE INVENTION

It is an object of the present invention to mitigate the above problems and to provide a convenient zoom function and/or by which zoom function one or more zoomed objects may be rendered in an appealing and/or convenient way in a video recording.

This and other objects are achieved by providing a system, a method and a computer program having the features in the independent claims. Preferred embodiments are defined in the dependent claims.

Hence, according to a first aspect of the present invention, there is provided a system for zooming of a video recording. The system is configured to detect at least one object in a first view of the video recording, track the detected at least one object, and select at least one of the tracked at least one object. The system is further configured to define the selected at least one object by at least one first boundary and define a second boundary, wherein at least one of the at least one first boundary is provided within the second boundary. Furthermore, the system is configured to define a third boundary and define a second view of the video recording corresponding to a view of the video recording defined by the third boundary. The system is further configured to perform at least one of an in-zooming of the video recording relative the first view of the video recording, by changing the third boundary such that the third boundary coincides with the second boundary, whereby the second view of the video recording, played in the size of the first view of the video recording, constitutes the in-zooming of the video recording, and an out-zooming of the video recording relative the second view of the video recording corresponding to a view of the video recording defined by the third boundary of decreased size relative the first view of the video recording, by changing the third boundary such that the third boundary coincides with the first view, whereby the second view of the video recording, played in the size of the first view of the video recording, constitutes the out-zooming of the video recording. The system is further configured to, in case at least one predetermined event occurs during the video recording: stop a performed in-zooming or out-zooming of the video recording, track the selected at least one object, re-define the selected at least one object by the at least one first boundary, re-define the second boundary, wherein at least one of the at least one first boundary is provided within the second boundary, and change the third boundary, whereby the second view of the video recording corresponds to a view of the video recording defined by the third boundary.

According to a second aspect of the present invention, there is provided a method for zooming of a video recording. The method comprises the steps of detecting at least one object in a first view of the video recording, tracking the detected at least one object, and selecting at least one of the tracked at least one object. The method further comprises defining the selected at least one object by at least one first boundary and defining a second boundary, wherein at least one of the at least one first boundary is provided within the second boundary. The method further comprises defining a third boundary and define a second view of the video recording corresponding to a view of the video recording defined by the third boundary. The method further comprises performing at least one of the steps of: in-zooming of the video recording relative the first view of the video recording, by changing the third boundary such that the third boundary coincides with the second boundary, whereby the second view of the video recording, played in the size of the first view of the video recording, constitutes the in-zooming of the video recording, and out-zooming of the video recording relative the second view of the video recording corresponding to a view of the video recording defined by the third boundary of decreased size relative the first view of the video recording, by changing the third boundary such that the third boundary coincides with the first view, whereby the second view of the video recording, played in the size of the first view of the video recording, constitutes the out-zooming of the video recording. The method further comprises the steps of, in case at least one predetermined event occurs during the video recording: stopping a performed at least one of an in-zooming and an out-zooming of the video recording, tracking the selected at least one object, re-defining the selected at least one object by the at least one first boundary, re-defining the second boundary, wherein at least one of the at least one first boundary is provided within the second boundary, and changing the third boundary, whereby the second view of the video recording corresponds to a view of the video recording defined by the third boundary.

According to a third aspect of the present invention, there is provided a computer program comprising computer readable code for causing a computer to carry out the steps of the method according to the second aspect of the present invention when the computer program is carried out on the computer.

Thus, the present invention is based on the idea of providing a system for zooming of a video recording. The system may detect, track and select one or more objects in a first view of the video recording. The system may thereafter automatically provide an in-zooming or out-zooming of the selected object(s). The performed in-zooming or out-zooming of the video recording may be stopped in case a predetermined event occurs, such as a interrupted tracking of at least one of the selected at least one object, a de-selection of at least one of the selected at least one object, and/or a selection of at least one object in the first view, separate from the selected at least one object. After the stopping of the video recording, the system may track the object(s), re-define the first and second boundaries accordingly and change the third boundary. The system may thereafter resume an in-zooming or out-zooming of the video recording.

It will be appreciated that the system of the present invention is primarily intended for a real-time zooming of a video recording, wherein the in- and/or out-zooming of the video recording is performed during the actual and ongoing video recording. However, the system of the present invention may alternatively be configured for a post-processing of the video recording, wherein the system may generate in- and/or out-zooming operations on a previously recorded video.

The present invention is advantageous in that the zooming of the object(s) during the video recording by the device is provided automatically by the system, thereby avoiding drawbacks related to manual zooming. The automatic zoom may conveniently zoom in on (or zoom out of) selected objects, often resulting in a more even, precise and/or smooth zooming of the video recording compared to a manual zooming operation. For example, an attempt of a manual zooming of one or more objects during a video recording may lead to a user losing track of the object(s) and/or that the object(s) move(s) out of the zoomed view. Furthermore, during a manual zooming, the user may unintentionally move the device which may result in a video where the object(s) is (are) not rendered in a desired way in the video recording. Furthermore, in case one or more events occur during the video recording, such as an interrupted tracking of one or more of the selected object(s), a de-selection of one or more of the selected at least one object, and/or a selection of one or more object(s) in the first view, separate from the selected object(s), the system may conveniently re-define the first and second boundaries and change the third boundary, which may lead to a convenient in-zooming or out-zooming of the video recording.

The present invention is further advantageous in that the system may provide a smooth and convenient in- and/or out-zooming of a video recording, leading to an esthetically appealing appearance of the resulting video recording. Furthermore, the experience of the video recording may be modified by changing the speed of the in- and/or out-zooming of the video recording.

It will be appreciated that the mentioned advantages of the system of the first aspect of the present invention also hold for the method according to the second aspect of the present invention.

According to the first aspect of the present invention, there is provided a system for zooming of a video recording. By the term “zooming”, it is here meant an in-zooming and/or an out-zooming of a first view of the video recording. The system is configured to detect at least one object in a first view of the video recording. By the term “first view”, it may hereby be meant a full view, a primary (unchanged, unzoomed) view, or the like, of the video recording. The system is configured to track the detected object(s). By the term “track”, it is here meant an automatic following of the detected object(s). The system is further configured to select one or more of the tracked object(s). Hence, the system may be configured to select none, all, or a subset of the tracked object(s).

The system is further configured to define the selected at least one object by at least one first boundary. Hence, each selected object may be defined by a first boundary, i.e. each selected object may be provided within a first boundary. The first boundary may also be referred to as a “tracker boundary”, or the like. The system is further configured to define a second boundary, wherein at least one of the at least one first boundary is provided within the second boundary. In other words, one or more of the first boundaries may be enclosed by a second boundary. The second boundary may also be referred to as a “target boundary”, or the like.

The system is further configured to define a third boundary and define a second view of the video recording corresponding to a view of the video recording defined by the third boundary. In other words, the second view corresponds to the resulting view of the video recording, i.e. the view of the video recording when the video recording is (re)played. The third boundary may also be referred to as a “zoom boundary”, or the like.

Furthermore, the system is configured to perform an in-zooming and/or an out-zooming. During an in-zooming of the video recording relative the first view of the video recording, the system is configured to change the third boundary such that the third boundary coincides with the second boundary, whereby the second view of the video recording, played in the size of the first view of the video recording, constitutes the in-zooming of the video recording. Analogously, during an out-zooming of the video recording relative the second view of the video recording corresponding to a view of the video recording defined by the third boundary of decreased size relative the first view of the video recording, the system is configured to change the third boundary such that the third boundary coincides with the first view, whereby the second view of the video recording, played in the size of the first view of the video recording, constitutes the out-zooming of the video recording. Hence, the third boundary is automatically moved, changed, shifted, increased, decreased and/or resized such that it coincides with the second boundary. Furthermore, as the second view corresponds to a view of the video recording defined by the third boundary, the move, change and/or resizing of the third boundary implies an in-zooming or out-zooming of the video recording relative the first view of the video recording.

Furthermore, it will be appreciated that one or more events may occur during the video recording. For example, a tracking of at least one of the selected at least one object may be interrupted, at least one of the selected at least one object may be de-selected, and/or at least one object in the first view, separate from the selected at least one object, may be selected. Then, the system is configured to perform the following: firstly, stop a performed in-zooming or out-zooming of the video recording. Hence, if an in-zooming or out-zooming is performed by the system, this zooming is interrupted. Secondly, track the selected at least one object. Thirdly, re-define the selected at least one object by the at least one first boundary. Fourthly, re-define the second boundary, wherein at least one of the at least one first boundary is provided within the second boundary, and fifthly, change the third boundary, whereby the second view of the video recording corresponds to a view of the video recording defined by the third boundary.

According to an embodiment of the present invention, the at least one first boundary may be provided within the second boundary, and the second boundary may be provided within the third boundary. The system may further be configured to decrease the size of the third boundary such that the third boundary coincides with the second boundary, whereby the second view of the video recording, played in the size of the first view of the video recording, constitutes an in-zooming of the video recording.

According to an embodiment of the present invention, the system may further be configured to detect the at least one object based on pattern recognition. The present embodiment is advantageous in that pattern recognition is a convenient and efficient manner of recognizing one or more objects.

According to an embodiment of the present invention, the system may be configured to define at least one predetermined criteria for selection of the at least one object, and select the tracked at least one object according to the at least one predetermined criteria. By the term “criteria”, it is here meant a criteria which may be linked to one or more characteristic features of an object, such as the size and/or speed of an object. The present embodiment is advantageous in that the system may conveniently select one or more tracked object(s) according to predetermined criteria and/or characteristics of the object(s).

According to an embodiment of the present invention, at least one of the at least one predetermined criteria is associated with the size of the at least one object, and the system is configured to select only the largest object of the detected at least one object.

According to an embodiment of the present invention, at least one of the at least one predetermined criteria is an action performed by the at least one object, the system further being configured to identify an action performed by at least one object, and associate the identified action with at least one of the at least one predetermined criteria, and select the at least one object performing the action. Hence, the system may be configured to match an action by one or more objects with a predetermined object action, and select the object(s) accordingly. By the term “action”, it is here meant substantially any movement performed by the object(s), such as running, walking, jumping, etc. The present embodiment is advantageous in that the system may efficiently and conveniently identify object(s) performing an action which may be desirable to emphasize in the video recording.

According to an embodiment of the present invention, the system may be configured to de-select at least one of the selected at least one object. By the term “de-select”, it is here meant a deletion, removal and/or deselection of one or more objects. The present embodiment is advantageous in that the system may de-select any object(s) which is of no interest to zoom into.

According to an embodiment of the present invention, the system may be configured to, in case there is no marked at least one object, increase the size of the third boundary such that the third boundary coincides with the first view, whereby the second view of the video recording, played in the size of the first view of the video recording, constitutes an out-zooming of the video recording relative the second view of the video recording corresponding to a view of the video recording defined by the third boundary of decreased size relative the first view of the video recording. In other words, if the system de-selects the (or all) object(s), the size of the third boundary increases. As the second view of the video recording corresponds to a view of the video recording defined by the third boundary, the second view constitutes an out-zooming of the video recording. The present embodiment is advantageous in that the system may interrupt the zooming and return to the first view of the video recording.

According to an embodiment of the present invention, the system is further configured to change the speed of at least one of the in-zooming and out-zooming of the video recording. The present embodiment is advantageous in that the video recording may be rendered in an even more dynamic manner. For example, the system may be configured to have a relatively high speed of the zooming for a livelier experience. Conversely, the system may be configured to have a relatively low and/or moderate speed of the zooming for a calmer experience.

According to an embodiment of the present invention, there is provided a user interface, UI, comprising a system according to any one of the preceding embodiments, for zooming of a video recording by a device, comprising a screen. The UI is configured to be used in conjunction with the device, wherein the device is configured to display the video recording on the screen.

According to an embodiment of the present invention, the user interface may be configured to display, on the screen, at least one of the at least one first boundary, the second boundary and the third boundary. The present embodiment is advantageous in that a user may see the conditions of the zooming operation of the UI, and, optionally, change one or more of the conditions. For example, if the UI is configured to display the one or more first boundary, a user may see which objects have been tracked and selected. Furthermore, if the UI is configured to display the second boundary, a user may see which boundary the UI intends to zoom towards by the third boundary. Furthermore, if the UI is configured to display the third boundary, a user may see how the zooming by the third boundary towards the second boundary may render the second view (i.e. the zoomed view) of the video recording.

According to an embodiment of the present invention, the user interface may be configured to display on the screen, at least one indication of a center portion of at least one of the at least one first boundary, the second boundary and the third boundary. The present embodiment is advantageous in that the center portion indication(s) may facilitate the user's conception of the center(s) of the boundary or boundaries, and consequently, the conception of the resulting video recording.

According to an embodiment of the present invention, the user interface may be a touch-sensitive user interface. By the term “touch-sensitive user interface”, it is here meant a UI which is able to receive an input by a user's touch, such as by one or more fingers of a user touching the UI. The present embodiment is advantageous in that a user, in an easy and convenient manner, may mark, indicate and/or select an object by touch, e.g. by the use of one or more fingers.

According to an embodiment of the present invention, the user interface may be configured to select at least one object based on a marking by a user on the screen on the at least one object, and subsequently, track the selected at least one object. The marking may comprise at least one tapping by the user on the screen on the at least one object. By the term “tapping”, it is here meant a relatively fast pressing of one or more fingers on the screen. The present embodiment is advantageous in that a user may conveniently mark an object visually appearing on the screen.

According to an embodiment of the present invention, the marking by a user on the screen of the at least one object may comprise an at least partially encircling marking of the at least one object on the screen. By the term “an at least partially encircling marking”, it is here meant a circular, circle-like, rectangular or quadratic marking of the user around one or more objects appearing on the screen. The present embodiment is advantageous in that it a user may intuitively and conveniently mark an object appearing on the screen.

According to an embodiment of the present invention, the user interface further comprises a user input function configured to associate at least one user input with at least one object on the screen, wherein the user input is selected from a group consisting of eye movement, face movement, hand movement and voice, and wherein the user interface is configured to select at least one object based on the user input function. In other words, the user input may comprise one or more eye movements, face movements (e.g. facial expression, grimace, etc.), hand movements (e.g. a gesture) and/or voice (e.g. voice command), and the user input function may hereby associate the user input with one or more objects on the screen. The present embodiment is advantageous in that the user interface is relatively versatile related to the selection of object(s), leading to a user interface which is even more user-friendly.

According to an embodiment of the present invention, the user input function is an eye-tracking function configured to associate at least one eye movement of a user with at least one object on the screen, and wherein the user interface is configured to select at least one object based on the eye-tracking function. The present embodiment is advantageous in that the eye-tracking function even further contributes to the efficiency and/or convenience of the operation of the user interface related to the selection of one or more objects.

According to an embodiment of the present invention, the user interface may further be configured to register an unmarking by a user on the screen of at least one of the at least one object, and de-select the at least one unmarked at least one object.

According to an embodiment of the present invention, the user interface may be configured to register at least one gesture by a user on the screen, and to associate the at least one gesture with a change of the second boundary. The user interface may furthermore be configured to display, on the screen, the change of the second boundary. By the term “gesture”, it is here meant a movement, a touch, a pattern created by the touch of at least one finger top, or the like, by the user on a touch-sensitive screen of a device. The present embodiment is advantageous in that the second boundary may be changed in an easy and intuitive manner. Furthermore, as the UI is configured to display the change (i.e. the move, re(sizing), or the like) of the second boundary, the user is provided with feedback from the change.

According to an embodiment of the present invention, the user interface may be configured to associate the at least one gesture with a change of size of the second boundary. In other words, the user may make the second boundary smaller or larger by a gesture registered on the screen. For example, the gesture may be a “pinch” gesture, whereby two or more fingers are brought towards each other.

According to an embodiment of the present invention, the user interface may further be configured to register a plurality of input points by a user on the screen, and scale the size of the second boundary based on the plurality of input points. By the term “input points”, it is here meant one or more touches, indications, or the like, by the user on the touch-sensitive screen. The present embodiment is advantageous in that the second boundary may be changed in an easy and intuitive manner.

According to an embodiment of the present invention, the user interface may further be configured to associate the at least one gesture with a re-positioning of the second boundary on the screen.

According to an embodiment of the present invention, the user interface may further be configured to register the at least one gesture as a scroll gesture by a user on the screen. By the term “scroll gesture”, it is here meant a gesture of a “drag-and-drop” type, or the like.

According to an embodiment of the present invention, the user interface may further be configured to estimate a degree of probability that the selected at least one object is moving out of the first view of the video recording. In case the degree of probability exceeds a predetermined probability threshold value, the user interface may be configured to generate at least one indicator for a user, and alert the user by the at least one indicator. The present embodiment is advantageous in that the UI may alert a user during a video recording that the object(s) that are selected are moving out of the first view of the video recording, such that the user may move and/or turn the video recording device to be able to continue to record the objects.

According to an embodiment of the present invention, the user interface may be configured to estimate the degree of probability based on an at least one of a location, an estimated velocity and an estimated direction of movement of the at least one object. The present embodiment is advantageous in that the inputs of location, velocity and/or estimated direction of movement of the object(s) may further improve the estimate of the degree of probability that object(s) are about to move out of the first view of the video recording.

According to an embodiment of the present invention, the user interface may further be configured to, in case the degree of probability exceeds the predetermined probability threshold value, display at least one visual indicator on the screen as a function of at least one of the location, the estimated velocity and the estimated direction of movement of the at least one object. The present embodiment is advantageous in that the user may be conveniently guided by the visual indicator(s) on the screen to move and/or turn the video recording device if necessary.

According to an embodiment of the present invention, the at least one visual indicator comprises at least one arrow.

According to an embodiment of the present invention, the device is configured to generate a tactile alert, and in case the degree of probability exceeds the predetermined probability threshold value, cause the device to a generate a tactile alert. By the term “tactile alert”, it is here meant e.g. a vibrating alert.

According to an embodiment of the present invention, the device is configured to generate an auditory alert, and in case the degree of probability exceeds the predetermined probability threshold value, cause the device to generate an auditory alert. By the term “auditory alert”, it is here meant e.g. a signal, an alarm, or the like.

According to an embodiment of the present invention, the user interface is configured to display, on a peripheral portion of the screen, the second view of the video recording. By the term “peripheral portion”, it is here meant a portion at an edge portion of the screen. The present embodiment is advantageous in that the user may be able to see the second view of the video recording, which constitutes a zooming of the video recording relative the first view of the video recording, at the peripheral portion of the screen.

According to an embodiment of the present invention, the user interface is configured to, in case a performed in-zooming or out-zooming of the video recording is stopped, generate at least one indicator for a user, and alert the user by the at least one indicator. For example, indicator may comprise a visual indicator, and the user interface may be configured to display the visual indicator on the screen. According to other examples, the indicator may comprise a tactile alert (e.g. a vibration), an auditory alert (e.g. an alarm), etc.

According to an embodiment of the present invention, there is provided a device for video recording, comprising a screen and a user interface according to any one of the preceding embodiments.

According to an embodiment of the present invention, there is provided a mobile device comprising a device for video recording, wherein the screen of the device is a touch-sensitive screen.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiment(s) of the invention.

FIGS. 1a-c are schematic views of a system according to an exemplifying embodiment of the present invention,

FIGS. 2-3 are schematic illustrations of flow charts of systems according to exemplifying embodiments of the present invention,

FIGS. 4a-b are schematic views of a user interface, UI, wherein a user may mark object(s), according to an exemplifying embodiment of the present invention,

FIGS. 5a-b are schematic views of the UI being configured to register an unmarking of an object by a user on a screen, according to an exemplifying embodiment of the present invention,

FIGS. 6a-b are schematic views of a UI being configured to adjust the zooming of an object, according to an exemplifying embodiment of the present invention,

FIGS. 7a-c are schematic views of a UI being configured to change the position of the second boundary, according to an exemplifying embodiment of the present invention,

FIGS. 8a-c are schematic views of a UI being configured to change the size of the second boundary, according to an exemplifying embodiment of the present invention,

FIG. 9 is a schematic view of a UI being configured to generate an alert, according to an exemplifying embodiment of the present invention, and

FIG. 10 is a schematic view of a mobile device for video recording, according to an exemplifying embodiment of the present invention.

### DETAILED DESCRIPTION

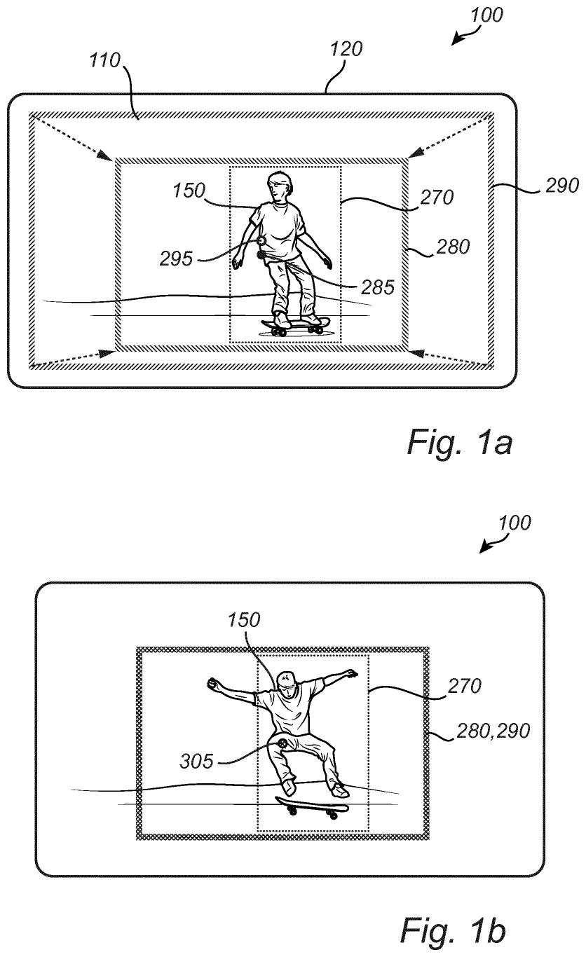

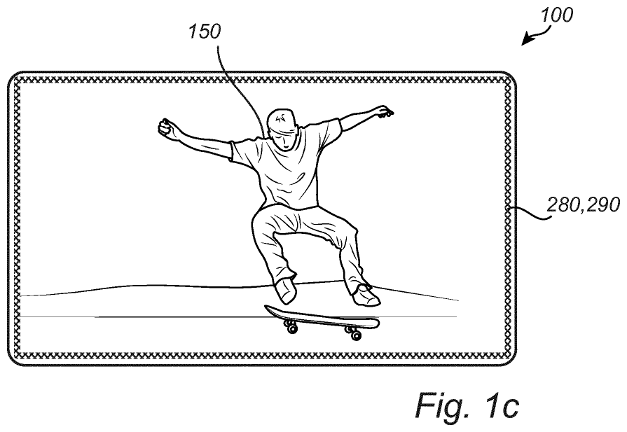

FIG. 1a is a schematic view of a system 100 for zooming of a video recording. For an increased understanding of the operation of the system 100, the zooming by the system 100 is exemplified by means of a device (e.g. a smartphone) comprising a screen 120.

The system 100 is configured to detect an object 150 in a first view 110 in the video recording on the screen 120, and to track (i.e. to follow) the detected object 150. In other words, the system 100 is able to track (follow) the detected object 150 during a movement of the object 150. It will be appreciated that a tracking function is known by the skilled person, and is not described in more detail.

The system 100 is further configured to select one or more of the tracked object(s) 150. The system 100 may be configured to select none, all, or a subset of the tracked object(s) 150. Furthermore, the system 100 may be configured to select one or more tracked objects(s) 150 according to one or more predetermined criteria. For example, one predetermined criteria may be associated with the size of the object(s) 150, and the system 100 may hereby be configured to select only the largest object 150 of a plurality of detected objects 150. Alternatively, the system 100 may be configured to identify an action performed by the object 150, associate the identified action with at least one of the at least one predetermined criteria, and select the object 150 performing the action. For example, the system 100 may be configured to identify the action of the object in FIG. 1 a as a movement of the object 150 having a speed which is above a predetermined threshold. If an action of this kind of the object 150 matches a predetermined object action, the system may select the object(s) 150 accordingly such that object(s) performing the action is (are) emphasized in the video.

The system 100 is further configured to define the tracked object 150 by at least one first boundary 270. In other words, the object 150 may be enclosed by the first boundary 270. Here, the first boundary 270 is exemplified as a rectangle which encloses (defines) the object 150. It will be appreciated that there may be more than one object 150 on the screen, and hence, there may be a plurality of first boundaries 270, each defining an object 150.

The system 100 is further configured to define a second boundary 280, wherein one or more of the first boundary(ies) 270 is provided within the second boundary 280. Hence, if there is more than one first boundary 270, some or all of these first boundaries 270 may be enclosed by the second boundary 280. For example, the system 100 may select at least one first boundary 270 to be provided within the second boundary 280. The center portion of the second boundary 280 is indicated by a marker 285. In one embodiment of the system 100, the second boundary 280 is displayed on the screen 120.

The system 100 is further configured to define a third boundary 290, provided within the first view 110 of the video recording, and to define a second view of the video recording corresponding to a view of the video recording defined by the third boundary 290. In other words, it is the second view of the video recording which may constitute the resulting video recording. The center portion of the third boundary 290 is indicated by a marker 295.

Furthermore, the system 100 is configured to automatically change and/or move the third boundary 290, as indicated by the schematic arrows at the corners of the third boundary 290, such that the third boundary 290 coincides with (i.e. adjusts to) the second boundary 280. In FIG. 1a, the second boundary 280 is provided within the third boundary 290, and the size of the third boundary 290 is decreased such that the third boundary 290 coincides with the second boundary 280.

The system 100 may be configured to stabilize the first view 110 and/or second view of the video recording. It will be appreciated that a stabilizing function of this kind is known by the skilled person, and is not described in more detail.

In FIG. 1b, the third boundary 290 has been automatically moved (decreased) such that it coincides with the second boundary 280. Accordingly, the marker 285 of the center portion of the second boundary 280 and the marker 295 of the center portion of the third boundary 290 of FIG. 1a have coincided, and the center portion of the third boundary 290 coinciding with the second boundary 280 is indicated by a marker 305. It will be appreciated that the second view corresponds to the view of the video recording defined by the third boundary 290, and in FIG. 1b, the second view of the video recording, played in the size of the first view of the video recording, hereby constitutes a zooming of the video recording relative the first view of the video recording. In other words, as the third boundary 290 is smaller than the first view, the second view results in a zooming of the video recording relative the first view. Hence, the operation results in a zooming of the object 150 in the video recording.

In FIG. 1c, the system 100 is configured to display the second view of the video recording in the size of the first view 110 of the video recording. In other words, the second view corresponding to the view of the video recording defined by the third boundary 290 in FIG. 1b may be displayed over the entire screen 120, such that the object 150 becomes zoomed in FIG. 1c compared to FIG. 1b.

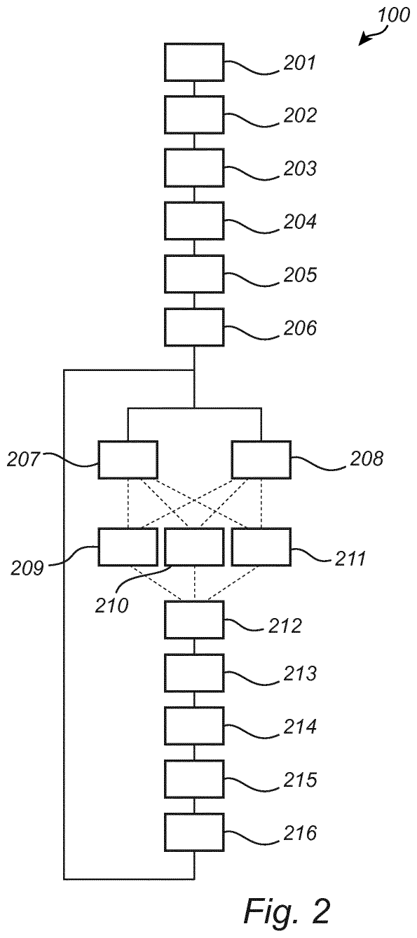

FIG. 2 is a schematic illustration of a flow chart of the system 100 according to an embodiment of the present invention. The system 100 is configured to detect 201 at least one object in a first view of the video recording. It will be appreciated that the object may be substantially any object, e.g. a person, animal, vehicle, etc. Furthermore, the system 100 may detect one or more objects based on pattern recognition.

The system 100 is further configured to track 202 the detected at least one object, and select 203 at least one of the tracked at least one object. The system 100 may be configured to select 203 at least one of the tracked object(s) according to one or more predetermined criteria. For example, at least one of the at least one predetermined criteria may be associated with the size of the at least one object, and the system 100 may hereby be configured to select 203 only the largest object of the detected objects. Alternatively, the system 100 may select the object(s) based on an identified action of the object(s).

The system 100 is further configured to define 204 the selected at least one object by at least one first boundary, to define 205 a second boundary, wherein at least one of the at least one first boundary is provided within the second boundary. The system 100 is further configured to define 206 a third boundary and define a second view of the video recording corresponding to a view of the video recording defined by the third boundary.

The system 100 may further be configured to perform an in-zooming 207 of the video recording relative the first view of the video recording. The in-zooming 207 may be performed by changing the third boundary such that the third boundary coincides with the second boundary, whereby the second view of the video recording, played in the size of the first view of the video recording, constitutes the in-zooming of the video recording.

Alternatively, the system 100 may be configured to perform an out-zooming 208 of the video recording relative the second view of the video recording corresponding to a view of the video recording defined by the third boundary of decreased size relative the first view of the video recording. The out-zooming 208 may be performed by changing the third boundary such that the third boundary coincides with the first view, whereby the second view of the video recording, played in the size of the first view of the video recording, constitutes the out-zooming of the video recording. It will be appreciated that the system 100 may be configured to change the speed of the in-zooming 207 and/or out-zooming 208 of the video recording.

During the in-zooming 207 or the out-zooming 208 performed by the system 100, one or more events or scenarios may occur. For example, a tracking 209 of at least one of the selected at least one object may, possibly, be interrupted. Furthermore, at least one of the selected at least one object may be de-selected 210 during the in-zooming 207 or the out-zooming 208 performed by the system 100. Yet another event or scenario may be that at least one object in the first view, separate from the selected at least one object, is selected 211 during the in-zooming 207 or the out-zooming 208 performed by the system 100. If one or more of the interrupted tracking 209, the de-selection 210 and the selection 211 as described occurs, the system 100 is configured to perform the following: stop 212 a performed in-zooming 207 or out-zooming 208 of the video recording, track 213 the selected at least one object, re-define 214 the selected at least one object by the at least one first boundary, re-define 215 the second boundary, wherein at least one of the at least one first boundary is provided within the second boundary, and change 216 the third boundary, whereby the second view of the video recording corresponds to a view of the video recording defined by the third boundary. After changing 216 the third boundary, the system 100 may either keep the present state of the video recording, perform an in-zooming 2017 or perform an out-zooming 208, as indicated by the iterative (feedback) line of FIG. 2.

The tracking 209 of one or more objects may be interrupted due to a movement of the object(s) out of the second view. In a case one or more objects return into the second view, the system 300 may be configured to recognize that the same object(s) has (have) returned into the second view and continue a performed in-zooming or out-zooming.

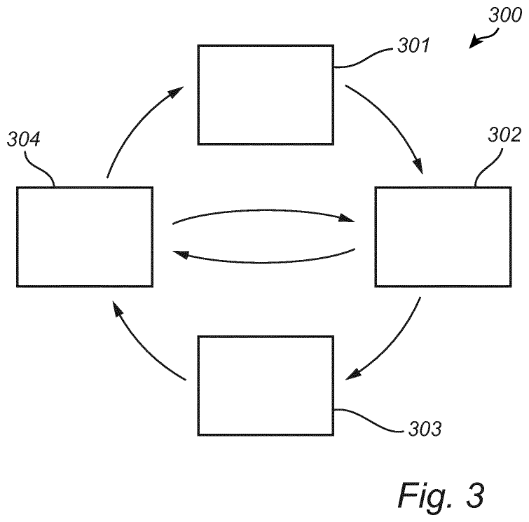

FIG. 3 is a schematic illustration of a system 300 according to an embodiment of the present invention, and may serve as an alternative presentation of the system 100 as described in FIG. 2. Here, at an initial stage of the procedure, the system 300 is configured to display the video recording in a first view, defined by the original (unzoomed) state 301. The system 200 may thereafter be configured to perform detection, tracking and selection of one or more objects, e.g. as described by 201, 202 and 203 in FIG. 2. Thereafter, the system 300 may be configured to perform an in-zooming 302 of the video recording, e.g. according to step 207 of FIG. 2, whereby an in-zoomed state 303 of the video recording is reached. Hence, at the stage 303, the system 200 may be configured to render an in-zoomed view of the video recording. At substantially any stage of the in-zoomed state 303, the system 200 may initiate an out-zooming 304 of the video recording, e.g. according to step 208 of FIG. 2, whereby the un-zoomed state 301 may be reached. Hence, at the stage 301, the system 200 may be configured to render the first view of the video recording.

During the state of in-zooming 302 and/or out-zooming 304 by the system 200, one or more interruptions, changes, or the like, may occur during the video recording. For example, as described in FIG. 2 by scenario 209, a tracking of at least one of the selected at least one object may, possibly, be interrupted during the in-zooming 207 or the out-zooming 208 performed by the system 100. Furthermore, at least one of the selected at least one object may be de-selected during the in-zooming 207 or the out-zooming 208 performed by the system 100, as described by scenario 210 in FIG. 2. Yet another scenario, as described by 211 in FIG. 2, may be that at least one object in the first view, separate from the selected at least one object, is selected during the in-zooming 207 or the out-zooming 208 performed by the system 100. In case one or more of these scenarios occur, the system 100 is configured to stop the performed in-zooming 302 or out-zooming 304 of the video recording, according to step 212 of FIG. 2. The system 200 may thereafter perform the steps according to 213-216 of FIG. 2, namely track the selected object(s), re-define the selected object(s) by one of more first boundary(ies), re-define the second boundary, and change the third boundary. Subsequently, if the system 200 is in the state of out-zooming 304, it may remain in the current state of the video recording corresponding to the state 304, zoom out to the un-zoomed state 301 or perform an in-zooming 302. Analogously, if the system 200 is in the state of in-zooming 302, it may remain in the current state of the video recording corresponding to the state 302, zoom in to the in-zoomed state 303 or perform an out-zooming 304.

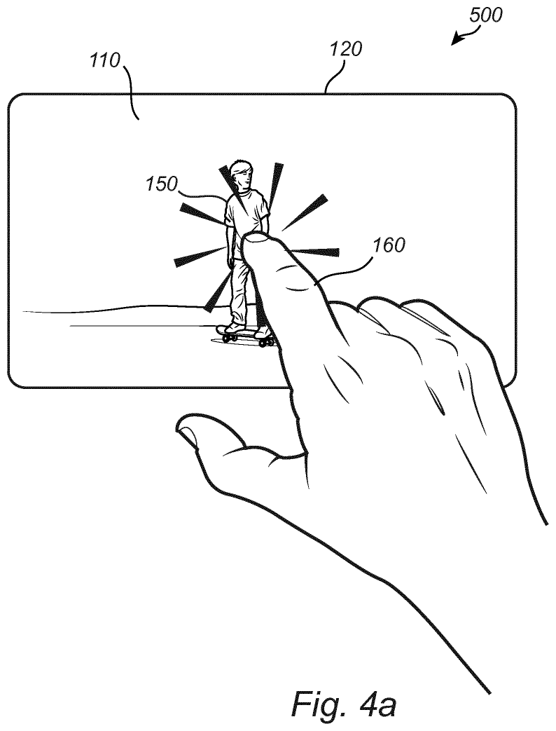

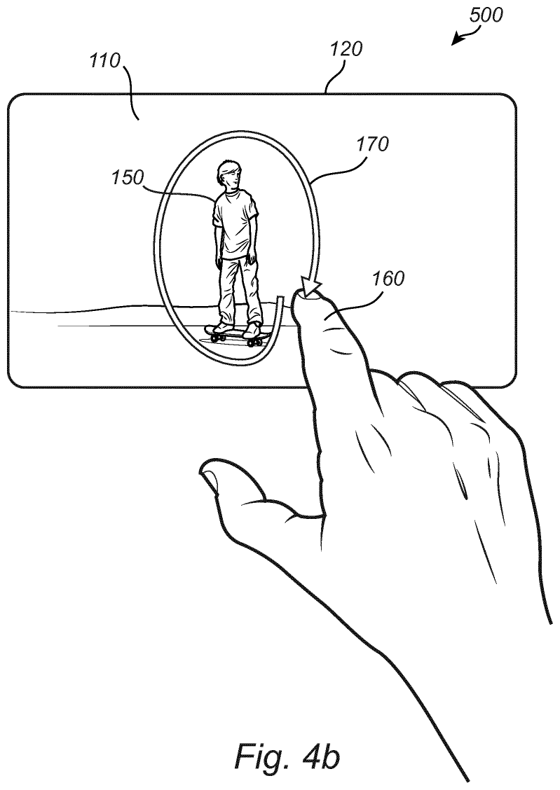

FIGS. 4a and 4b are schematic views of a user interface 500, UI, comprising a system according to any one of the preceding embodiments. The UI 500 is configured to zoom a first view of a video recording by a device comprising a screen 120. The device, is configured to display a first view 110 of the video recording on the screen 120. It will be appreciated that the device may be substantially any device comprising a video recording function, e.g. a smartphone. The zooming of the first view may be started by a user who marks an object 150 present on the screen 120 in the first view 110, whereby the UI 500 is configured to register this marking and to associate the marking with the object 150. In FIG. 4a, the marking of the object 150 comprises a tapping on the screen 120 by a finger 160 of the user. Alternatively, and as shown in FIG. 4b, the marking of the object 150 may comprise an at least partially encircling marking 170 of the object 150 on the screen. For example, the user may hold down a finger 160 and draw or indicate a circle around the object 150. By these marking(s) of one or more objects 150 present in the video recording on the screen, the UI 500 is provided with user input. If there is more than one object, the UI 500 may be configured to register a plurality of objects 150. Although not indicated in FIG. 4a, the UI may further comprise a user input function configured to associate at least one user input (e.g. eye movement, face movement, hand movement, voice, etc.) with one or more objects 150 on the screen, and wherein the UI 500 is configured to select one or more objects 150 based on the user input function. For example, the user input function may be an eye-tracking function configured to associate at least one eye movement of a user with one or more objects 150 on the screen, and wherein the UI 500 is configured to select the object(s) 150 based on the eye-tracking function. As yet another example, a user may provide user input by his/her voice, in terms of a voice command. For example, by the voice command “child”, “house”, “animal”, etc., the user input function may be configured to associate the voice command with a child, house, animal, respectively, on the screen, and the UI 500 may hereby be configured to select one or more of these object(s) 150. It will be appreciated that the UI 500 may be configured to generate at least one indicator for a user, and alert the user by the at least one indicator, in case the system stops a performed in-zooming or out-zooming of the video recording. For example, the indicator may comprise a visual indicator, and the UI 500 may be configured to display the visual indicator on the screen. According to other examples, the device of the UI 500 may be configured to generate a tactile alert (e.g. a vibration), an auditory alert (e.g. an alarm), etc.

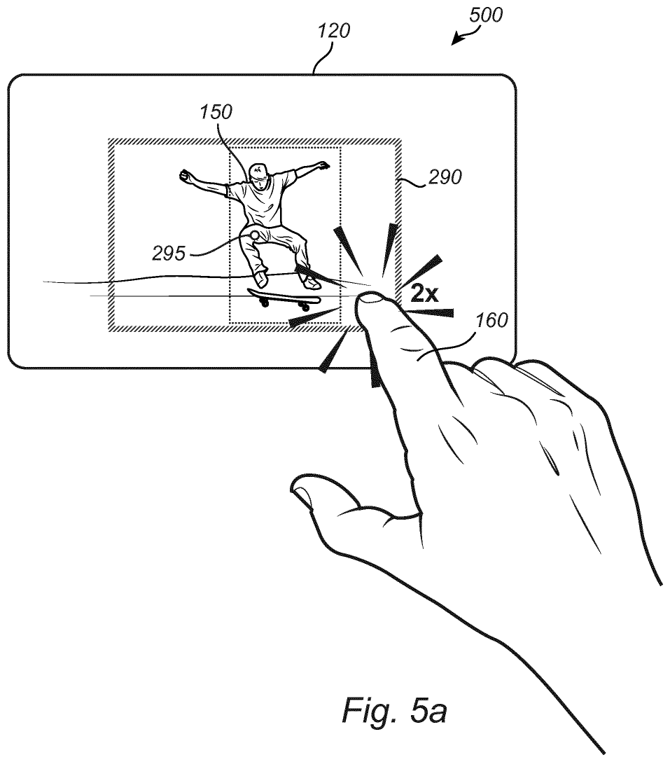

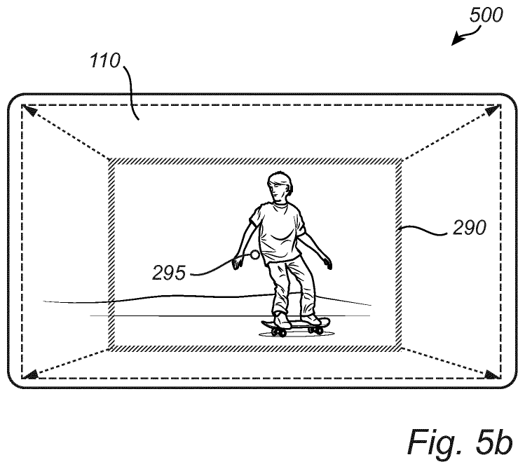

FIG. 5a is a schematic view of a UI 500 being configured to register an unmarking by a user on the screen 120 of one or more objects 150. Here, the unmarking of the object 150 comprises a double tapping on the screen 120 by a finger 160 of the user. In case there is at least one marked object 150 remaining after the unmarking operation, the UI 500 is configured to (re)define a second boundary, wherein the second boundary encloses all remaining (i.e. marked) objects 150. Furthermore, in case the unmarking of the user leads to the situation where there is no marked object 150, the size of the third boundary 290 is increased such that the third boundary 290 coincides with the first view, as shown in FIG. 5b. Consequently, the second view of the video recording, played in the size of the first view of the video recording, constitutes an out-zooming of the video recording relative the second view of the video recording, when the second view corresponds to a view of the video recording defined by the third boundary 290 of decreased size relative the first view of the video recording. Analogously with the exemplifying embodiment of Fig. la, the UI 500 may be configured to stabilize the first view 110 and/or the second view of the video recording.

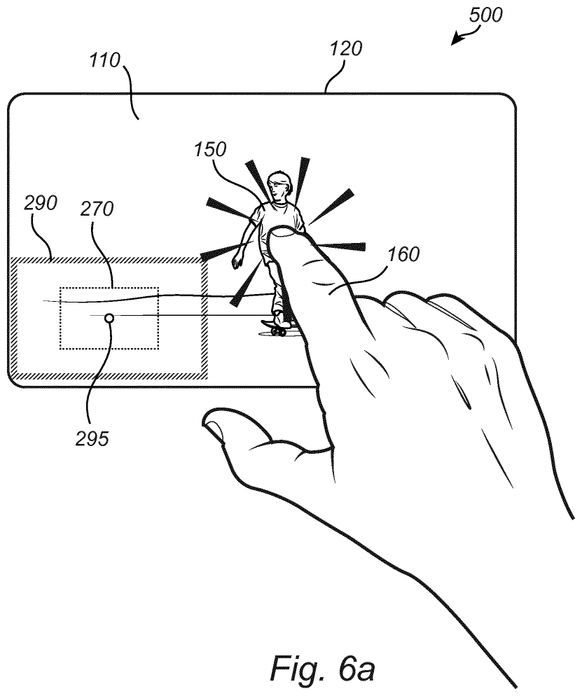

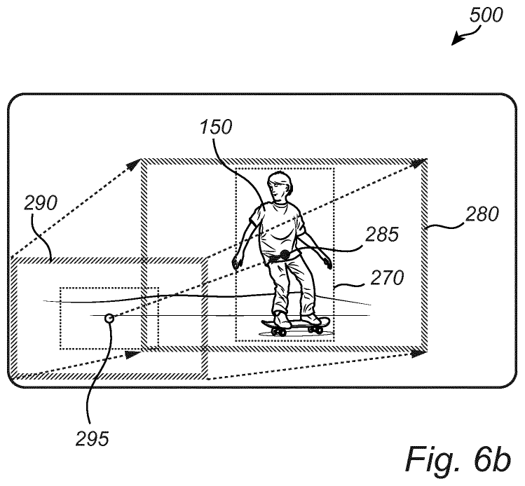

FIGS. 6a-b are schematic views of a UI 500 being configured to adjust the zooming of a first view of a video recording. In FIG. 6a, an object 150 in the first view 110 is outside the first boundary 270 and also, outside the third boundary 290. Here, the UI 500 may register a marking by a user on the screen of the object 150 in the first view 110 of the video recording on the screen, e.g. by a (single) tapping by a finger 160 of a user. In accordance with previously described operations, the UI 500 may be configured to associate the marking with the object 150, and cause the system to track the marked object 150. As shown in FIG. 6b, the UI 500 is configured to (re)define the tracked object 150 by a first boundary 270, to define a second boundary 280 which encloses (defines) the first boundary 270 and to change, move and/or resize the third boundary 290 such that the third boundary 290 coincides with the second boundary 280. This change, move and/or resizing of the third boundary 290 is schematically indicated by the arrows in FIG. 6b. Accordingly, the marker 285 of the center portion of the second boundary 280 and the marker 295 of the center portion of the third boundary 290 will coincide upon moving (changing/resizing) the third boundary 290.

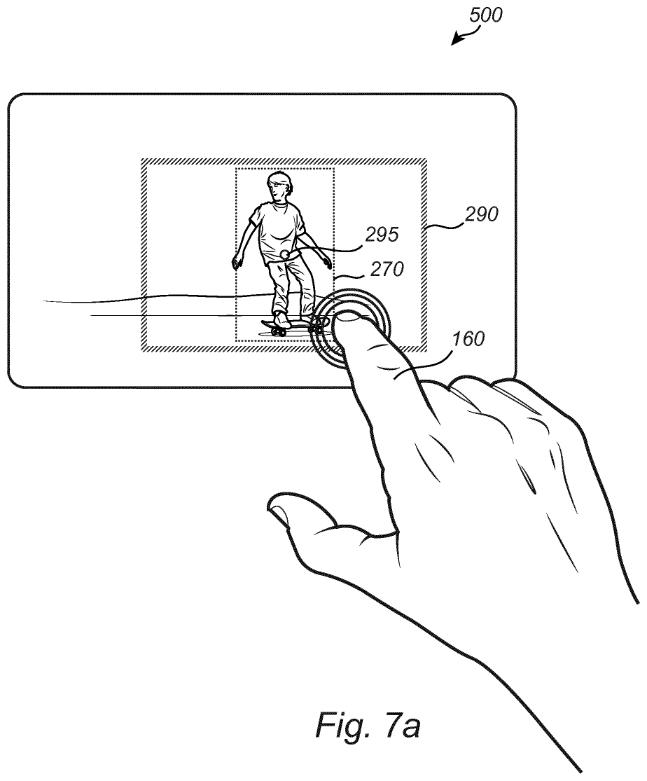

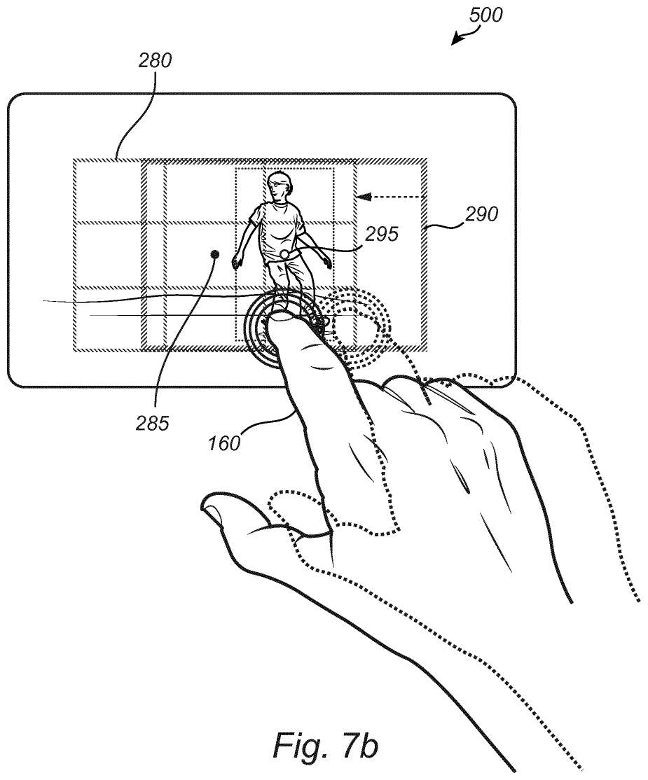

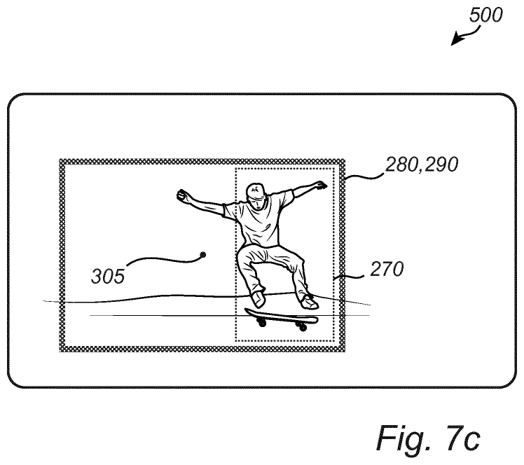

FIGS. 7a-c are schematic views of a UI 500 being configured to change the position of the second boundary 280 on the screen. In FIG. 7a, the UI 500 is configured to register a gesture by a user on the screen. In FIGS. 7a-b, the gesture is exemplified as a scroll gesture, a “drag-and-drop” gesture, or the like. The UI 500 is configured to register a touch by a finger 160 of the user on the screen (FIG. 7a) and to register a movement of the finger 160 on the screen to the left (FIG. 7b). During the movement of the finger 160 on the screen, which is exemplified in FIG. 7b as a movement of the finger 160 from right to left, the UI 500 is configured to move the second boundary 280 accordingly, and optionally, to display the movement of the second boundary 280 on the screen. It will be appreciated that a display of the second boundary 280 in the form of sub-frames is purely optional. In FIG. 7c, the third boundary 290 has been changed (moved), such that the third boundary 290 coincides with the second boundary 280. Furthermore, the markers 285 and 295 of FIG. 7b have coincided into the marker 305 of FIG. 7c. The resulting second view of the video recording, played in the size of the first view of the video recording, constitutes a zooming of the video recording relative the first view of the video recording, whereby the object 150 is positioned in a right hand side portion of the third boundary 290. The shift of the third boundary 290 is indicated by the marker 305 of the center portion of the third boundary 290, as the object 150 is found to the right of the marker 305. The shift of the third boundary 290 may furthermore be indicated by optionally displaying the first boundary 270, which is found at a right hand side portion of the third boundary 290. In other words, in this embodiment of the present invention, the user may manually shift the center of the resulting second view of the video recording. Furthermore, a user may improve the experience of a recorded sequence by the operations in FIGS. 7a-7c, e.g. by using the so called “rule of thirds” when shifting the center of the second view.

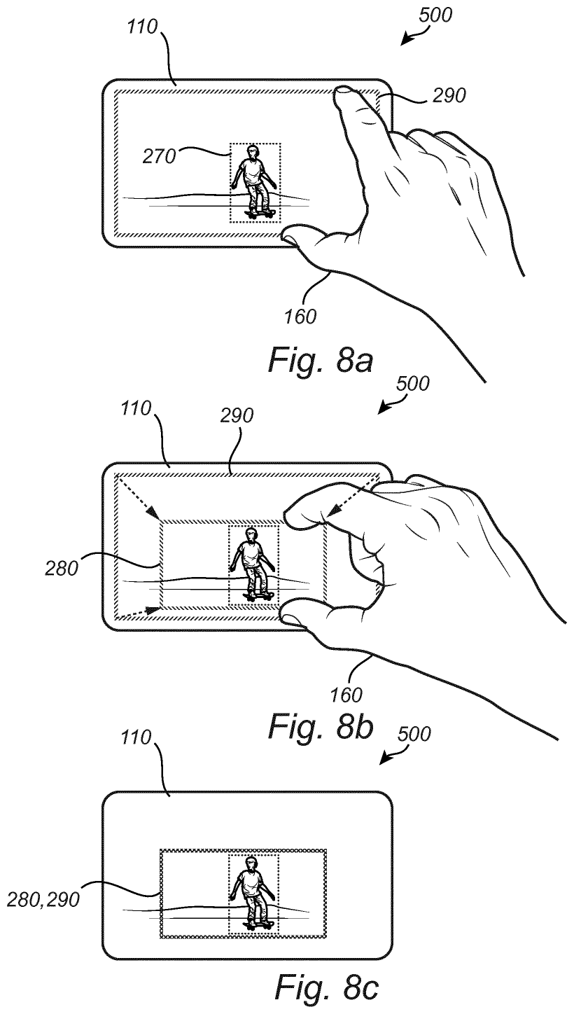

FIGS. 8a-c are schematic views of a UI 500 being configured to change the size of the second boundary 280. In FIGS. 8a-b, the UI 500 is configured to register at least one location of a plurality of input points (e.g. by two fingers 160 of a user) on the screen, and register at least one movement of at least one of the plurality of input points by a user on the screen. This operation may furthermore be referred to as a pinch gesture by two or more fingers 160 of a user on the screen. In FIG. 8b, the UI 500 is configured to register the pinch gesture described above as a decrease of size of the second boundary 280, and the UI 500 may hereby scale the size of the second boundary 280 based on the at least one location and the at least one movement of the plurality of input points provided by the user. In FIG. 8c, the third boundary 290 has been decreased in size compared to the size of the third boundary 290 in FIG. 8b. In other words, the resulting second view of FIG. 8c of the video recording, played in the size of the first view of the video recording, constitutes a zoomed video recording. It will be appreciated that the change of size of the second boundary 280 by the user may, analogously, constitute an enlargement of the second boundary 280 such that a resulting second view of the video recording constitutes a “less” zoomed video recording relative the zooming showed in FIG. 8b.

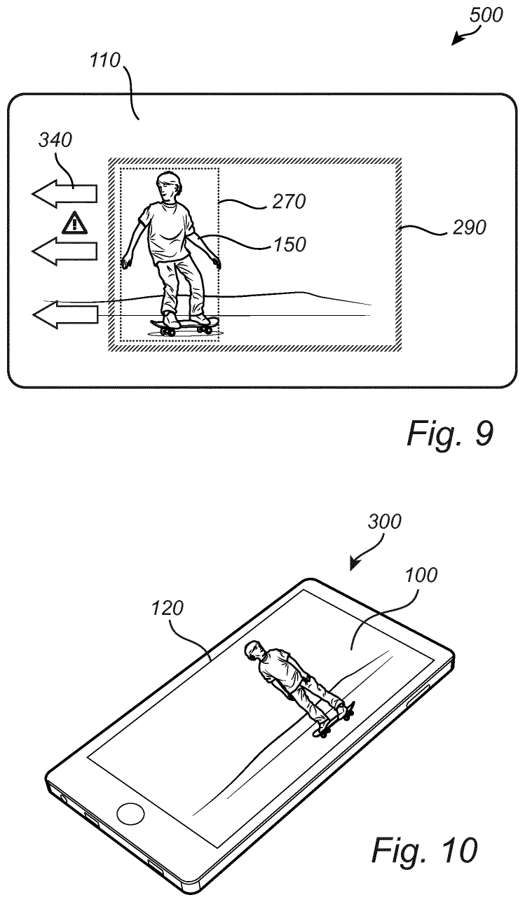

FIG. 9 is a schematic view of a UI 500 being configured to generate an alert for a user that an object 150 may be about to leave the first view 110 of the video recording. Firstly, the UI 500 is configured to estimate a degree of probability that the selected object 150, defined by the first boundary 270, is moving out of the first view 110 of the video recording. Here, the second view of the video recording, i.e. the zooming of the video recording relative the first view of the video recording, corresponds to a view of the video recording defined by the third boundary 290. It will be appreciated that the probability may be based on at least one of a location, an estimated velocity and an estimated direction of movement of the object 150. In case the degree of probability exceeds a predetermined probability threshold value, the UI 500 may be configured to generate at least one indicator for a user, and alert the user by the at least one indicator. In FIG. 9, there is provided an example of this alert/alarm function, wherein an object 150 is moving relatively quickly to the left in the first view 110. As the UI 500 may estimate and/or predict that the object 150 is about to leave the first view 110 at a left hand side portion of the first view 110, based on the object's location, velocity and/or direction of movement, the UI 500 is configured to display three arrows 340 as visual indicators on a left hand side portion of the screen such that a user may be informed that he or she should turn the video recording device for a continuous video recording of the object. It will be appreciated that the UI 500 furthermore may be configured to cause the device to generate an auditory and/or audial alert (e.g. an alarm) and/or a tactile alert (e.g. a vibration) if the object 150 is about to leave the first view 110 of the video recording.

FIG. 10 is a schematic view of a mobile device 300 for video recording comprising a UI 500 according to any one of the preceding embodiments, and further comprising a touch-sensitive screen 120. The mobile device 300 is exemplified as a mobile phone, e.g. a smartphone, but it will be appreciated that the mobile device 300 alternatively may be substantially any device configured for video recording.

The person skilled in the art realizes that the present invention by no means is limited to the preferred embodiments described above. On the contrary, many modifications and variations are possible within the scope of the appended claims. For example, it will be appreciated that the figures are merely schematic views of a user interface according to embodiments of the present invention. Hence, any functions and/or elements of the UI 500 such as one or more of the first 270, second 280 and/or third 290 boundaries may have different dimensions, shapes and/or sizes than those depicted and/or described.

### LIST OF EMBODIMENTS

1. A system (100) for zooming of a video recording, the system being configured to:
detect at least one object in a first view (110) of the video recording,
track the detected at least one object,
select at least one of the tracked at least one object,
define the selected at least one object by at least one first boundary (270),
define a second boundary (280), wherein at least one of the at least one first boundary is provided within the second boundary, and
define a third boundary (290) and define a second view of the video recording corresponding to a view of the video recording defined by the third boundary,
the system further being configured to perform at least one of:
an in-zooming of the video recording relative the first view of the video recording, by changing the third boundary such that the third boundary coincides with the second boundary, whereby the second view of the video recording, played in the size of the first view of the video recording, constitutes the in-zooming of the video recording, and
an out-zooming of the video recording relative the second view of the video recording corresponding to a view of the video recording defined by the third boundary of decreased size relative the first view of the video recording, by changing the third boundary such that the third boundary coincides with the first view, whereby the second view of the video recording, played in the size of the first view of the video recording, constitutes the out-zooming of the video recording,
the system further being configured to, in case at least one predetermined event occurs during the video recording:
stop a performed in-zooming or out-zooming of the video recording,
track the selected at least one object,
re-define the selected at least one object by the at least one first boundary,
re-define the second boundary, wherein at least one of the at least one first boundary is provided within the second boundary, and
change the third boundary, whereby the second view of the video recording corresponds to a view of the video recording defined by the third boundary.

2. The system according to embodiment 1, wherein the at least one predetermined event is selected from a group consisting of
an interrupted tracking of at least one of the selected at least one object,
a de-selection of at least one of the selected at least one object, and
a selection of at least one object in the first view, separate from the selected at least one object.

3. The system according to embodiment 1 or 2, wherein the at least one first boundary is provided within the second boundary, and the second boundary is provided within the third boundary, the system further being configured to
decrease the size of the third boundary such that the third boundary coincides with the second boundary, whereby the second view of the video recording, played in the size of the first view of the video recording, constitutes an in-zooming of the video recording relative the first view of the video recording.

4. The system according to any one of the preceding embodiments, further being configured to:
detect the at least one object based on pattern recognition.

5. The system according to any one of the preceding embodiments, further being configured to define at least one predetermined criteria for selection of the at least one object, and select the tracked at least one object according to the at least one predetermined criteria.

6. The system according to embodiment 5, wherein at least one of the at least one predetermined criteria is associated with the size of the at least one object, and wherein the system is configured to select only the largest object of the detected at least one object.

7. The system according to embodiment 5, wherein at least one of the at least one predetermined criteria is an action performed by the at least one object, the system further being configured to
identify an action performed by at least one object, and
associate the identified action with at least one of the at least one predetermined criteria, and select the at least one object performing the action.

8. The system according to any one of the preceding embodiments, further being configured to de-select at least one of the selected at least one object.

9. The system according to embodiment 8, further being configured to, in case there is no selected at least one object,
increase the size of the third boundary such that the third boundary coincides with the first view, whereby the second view of the video recording, played in the size of the first view of the video recording, constitutes an out-zooming of the video recording relative the second view of the video recording corresponding to a view of the video recording defined by the third boundary of decreased size relative the first view of the video recording.

10. The system according to any one of the preceding embodiments, further being configured to change the speed of at least one of the in-zooming and out-zooming of the video recording.

11. A user interface (500), UI, comprising
a system according to any one of the preceding embodiments, for zooming of a video recording by a device, comprising a screen, the UI being configured to be used in conjunction with the device, wherein the device is configured to display the video recording on the screen.

12. The user interface according to embodiment 11, further being configured to display, on the screen, at least one of the at least one first boundary, the second boundary and the third boundary.

13. The user interface according to embodiment 12, further being configured to display, on the screen, at least one indication (285, 295) of a center portion of at least one of the at least one first boundary, the second boundary and the third boundary.

14. The user interface according to any one of the embodiments 11-13, wherein the user interface is a touch-sensitive user interface.

15. The user interface according to embodiment 14, further being configured to select at least one object based on a marking by a user on the screen on the at least one object, and subsequently, track the selected at least one object.

16. The user interface according to embodiment 15, wherein the marking by a user on the screen of at least one object comprises at least one tapping by the user on the screen on the at least one object.

17. The user interface according to embodiment 15 or 16, wherein the marking by a user on the screen of the at least one object comprises an at least partially encircling marking of the at least one object on the screen.

18. The user interface according to any one of the embodiments 11-17, further comprising a user input function configured to associate at least one user input with at least one object on the screen, wherein the user input is selected from a group consisting of eye movement, face movement, hand movement and voice, and wherein the user interface is configured to select at least one object based on the user input function.

19. The user interface according to embodiment 18, wherein the user input function is an eye-tracking function configured to associate at least one eye movement of a user with at least one object on the screen, and wherein the user interface is configured to select at least one object based on the eye-tracking function.

20. The user interface according to any one of the embodiments 11-19, further being configured to:
register an unmarking by a user on the screen of at least one of the at least one object, and
de-select the at least one unmarked at least one object.

21. The user interface according to any one of the embodiments 11-20, further being configured to:
register at least one gesture by a user on the screen, and to associate the at least one gesture with a change of the second boundary, and to
display, on the screen, the change of the second boundary.

22. The user interface according to embodiment 21, further being configured to:
associate the at least one gesture with a change of size of the second boundary.

23. The user interface of embodiment 22, further being configured to:
register at least one location of a plurality of input points by a user on the screen, and register at least one movement of at least one of the plurality of input points by a user on the screen, and
scale the size of the second boundary based on the at least one location and the at least one movement of the plurality of input points.

24. The user interface according to any one of the embodiments 19-23, further being configured to associate the at least one gesture with a re-positioning of the second boundary on the screen.

25. The user interface according to embodiment 24, further being configured to register the at least one gesture as a scroll gesture by a user on the screen.

26. The user interface according to any one of the embodiments 11-25, further being configured to:
estimate a degree of probability that the selected at least one object is moving out of the first view of the video recording, and, in case the degree of probability exceeds a predetermined probability threshold value, to
generate at least one indicator for a user, and alert the user by the at least one indicator.

27. The user interface according to embodiment 26, further being configured to:
estimate the degree of probability based on an at least one of a location, an estimated velocity and an estimated direction of movement of the at least one object.

28. The user interface according to embodiment 26 or 27, further being configured to:
in case the degree of probability exceeds the predetermined probability threshold value, display at least one visual indicator on the screen as a function of at least one of the location, the estimated velocity and the estimated direction of movement of the at least one object.

29. The user interface according to embodiment 28, wherein the at least one visual indicator comprises at least one arrow.

30. The user interface according to any one of the embodiments 26-29, and wherein the device is configured to generate a tactile alert, the user interface further being configured to:
in case the degree of probability exceeds the predetermined probability threshold value, cause the device to a generate a tactile alert.

31. The user interface according to any one of the embodiments 26-30, and wherein the device is configured to generate an auditory alert, further being configured to:
in case the degree of probability exceeds the predetermined probability threshold value, cause the device to generate an auditory alert.

32. The user interface according to any one of the embodiments 11-31, further being configured to display, on a peripheral portion of the screen, the second view of the video recording.

33. The user interface according to any one of the embodiments 11-32, further being configured to, in case a performed in-zooming or out-zooming of the video recording is stopped,
generate at least one indicator for a user, and alert the user by the at least one indicator.

34. The user interface according to embodiment 33, wherein the at least one indicator comprises a visual indicator, and wherein the user interface is configured to, in case a performed in-zooming or out-zooming of the video recording is stopped,
display the visual indicator on the screen.

35. The user interface according to embodiment 33 or 34, wherein the at least one indicator comprises a tactile alert, and wherein the user interface is configured to:
in case a performed in-zooming or out-zooming of the video recording is stopped, cause the device to generate the tactile alert.

36. The user interface according to any one of embodiments 33-35, wherein the at least one indicator comprises an auditory alert, and wherein the user interface is configured to:
in case a performed in-zooming or out-zooming of the video recording is stopped, cause the device to generate the auditory alert.

37. A device for video recording, comprising
a screen (120), and
a user interface according to any one of the embodiments 11-36.

38. A mobile device (300), comprising
a device according to the embodiment 37, wherein the screen of the device is a touch-sensitive screen.

39. A method for zooming of a video recording, the method comprising the steps of:
detecting at least one object in a first view of the video recording,
tracking the detected at least one object,
selecting at least one of the tracked at least one object,
defining the selected at least one object by at least one first boundary,
defining a second boundary, wherein at least one of the at least one first boundary is provided within the second boundary, and
defining a third boundary and define a second view of the video recording corresponding to a view of the video recording defined by the third boundary,
wherein the method further comprises performing at least one of the steps of:
in-zooming of the video recording relative the first view of the video recording, by changing the third boundary such that the third boundary coincides with the second boundary, whereby the second view of the video recording, played in the size of the first view of the video recording, constitutes the in-zooming of the video recording, and
out-zooming of the video recording relative the second view of the video recording corresponding to a view of the video recording defined by the third boundary of decreased size relative the first view of the video recording, by changing the third boundary such that the third boundary coincides with the first view, whereby the second view of the video recording, played in the size of the first view of the video recording, constitutes the out-zooming of the video recording,
wherein the method further comprises the steps of, in case at least one predetermined event occurs during the video recording:
stopping a performed at least one of an in-zooming and an out-zooming of the video recording,
tracking the selected at least one object,
re-defining the selected at least one object by the at least one first boundary,
re-defining the second boundary, wherein at least one of the at least one first boundary is provided within the second boundary, and
changing the third boundary, whereby the second view of the video recording corresponds to a view of the video recording defined by the third boundary.

40. The method according to embodiment 39, wherein the at least one predetermined event is selected from a group consisting of
an interrupted tracking of at least one of the selected at least one object,
a de-selection of at least one of the selected at least one object, and
a selection of at least one object in the first view, separate from the selected at least one object.

41. A computer program comprising computer readable code for causing a computer to carry out the steps of the method according to embodiment 40 or 41 when the computer program is carried out on the computer.

1. A system for zooming of a video recording, the system being configured to:
detect at least one object in a first view of the video recording,
track the detected at least one object,
select at least one of the tracked at least one object,
define the selected at least one object by at least one first boundary,
define a second boundary, wherein at least one of the at least one first boundary is provided within the second boundary, and
define a third boundary and a second view of the video recording corresponding to a view of the video recording defined by the third boundary,
the system further being configured to perform at least one of:
an in-zooming of the video recording relative to the first view of the video recording, by changing the third boundary such that the third boundary coincides with the second boundary, whereby the second view of the video recording, played in the size of the first view of the video recording, constitutes the in-zooming of the video recording, or
an out-zooming of the video recording relative to the second view of the video recording corresponding to a view of the video recording defined by the third boundary of decreased size relative to the first view of the video recording, by changing the third boundary such that the third boundary coincides with the first view, whereby the second view of the video recording, played in the size of the first view of the video recording, constitutes the out-zooming of the video recording,
the system further being configured to, in case at least one predetermined event occurs during the video recording:
stop a performed at least one of an in-zooming or an out-zooming of the video recording,
track the selected at least one object,
re-define the selected at least one object by the at least one first boundary,
re-define the second boundary, wherein at least one of the at least one first boundary is provided within the second boundary, and
change the third boundary, whereby the second view of the video recording corresponds to a view of the video recording defined by the third boundary.

2. The system according to claim 1, wherein the at least one predetermined event is selected from
an interrupted tracking of at least one of the selected at least one object,
a de-selection of at least one of the selected at least one object, or
a selection of at least one object in the first view, separate from the selected at least one object.

3. The system according to claim 2, wherein the at least one first boundary is provided within the second boundary, and the second boundary is provided within the third boundary, the system further being configured to perform the in-zooming of the video recording by decreasing the size of the third boundary such that the third boundary coincides with the second boundary.

4. The system according to claim 1, further being configured to detect the at least one object based on pattern recognition.

5. The system according to claim 1, further being configured to:
define a predetermined at least one criteria for selection of the at least one object, and
select the tracked at least one object according to the predetermined at least one criteria.

6. The system according to claim 1, further being configured to de-select at least one of the selected at least one object.

7. The system according to claim 6, further being configured to, in case there is no selected at least one object,
perform an out-zooming of the video recording.

8. A user interface (UI), comprising one or more components configured to zoom a video recording, the UI being configured to be used in conjunction with a device comprising a screen, wherein the one or more components of the user interface are configured to:
detect at least one object in a first view of the video recording,
track the detected at least one object,
select at least one of the tracked at least one object,
define the selected at least one object by at least one first boundary,
define a second boundary, wherein at least one of the at least one first boundary is provided within the second boundary, and
define a third boundary and a second view of the video recording corresponding to a view of the video recording defined by the third boundary,
the one or more components of the user interface further being configured to perform at least one of:
an in-zooming of the video recording relative to the first view of the video recording, by changing the third boundary such that the third boundary coincides with the second boundary, whereby the second view of the video recording, played in the size of the first view of the video recording, constitutes the in-zooming of the video recording, or
an out-zooming of the video recording relative to the second view of the video recording corresponding to a view of the video recording defined by the third boundary of decreased size relative to the first view of the video recording, by changing the third boundary such that the third boundary coincides with the first view, whereby the second view of the video recording, played in the size of the first view of the video recording, constitutes the out-zooming of the video recording,
the one or more components of the user interface further being configured to, in case at least one predetermined event occurs during the video recording:
stop a performed at least one of an in-zooming or an out-zooming of the video recording,
track the selected at least one object,
re-define the selected at least one object by the at least one first boundary,
re-define the second boundary, wherein at least one of the at least one first boundary is provided within the second boundary, and
change the third boundary, whereby the second view of the video recording corresponds to a view of the video recording defined by the third boundary.

9. The user interface according to claim 8, wherein the user interface comprises a touch-sensitive user interface.

10. The user interface according to claim 8, wherein the one or more components are configured to select at least one object based on a marking by a user on the screen of the at least one object, and subsequently, track the selected at least one object.

11. The user interface according to claim 10, wherein the marking comprises at least one tapping by the user on the screen on the at least one object.

12. The user interface according to claim 10, wherein the marking by a user on the screen of the at least one object comprises an at least partially encircling marking of the at least one object on the screen.

13. The user interface according to claim 8, wherein the one or more components are further configured to:
register an unmarking by a user on the screen of at least one of the at least one object, and
de-select the thereby at least one unmarked at least one object.

14. A device for video recording, comprising
a screen, and
a user interface comprising one or more components configured to zoom a video recording, the user interface being configured to be used in conjunction with a device comprising a screen, wherein the one or more components of the user interface are configured to:
detect at least one object in a first view of the video recording,
track the detected at least one object,
select at least one of the tracked at least one object,
define the selected at least one object by at least one first boundary,
define a second boundary, wherein at least one of the at least one first boundary is provided within the second boundary, and
define a third boundary and define a second view of the video recording corresponding to a view of the video recording defined by the third boundary,
the one or more components of the user interface further being configured to perform at least one of:
an in-zooming of the video recording relative to the first view of the video recording, by changing the third boundary such that the third boundary coincides with the second boundary, whereby the second view of the video recording, played in the size of the first view of the video recording, constitutes the in-zooming of the video recording, or
an out-zooming of the video recording relative to the second view of the video recording corresponding to a view of the video recording defined by the third boundary of decreased size relative to the first view of the video recording, by changing the third boundary such that the third boundary coincides with the first view, whereby the second view of the video recording, played in the size of the first view of the video recording, constitutes the out-zooming of the video recording,
the one or more components of the user interface further being configured to, in case at least one predetermined event occurs during the video recording:
stop a performed at least one of an in-zooming or an out-zooming of the video recording,
track the selected at least one object,
re-define the selected at least one object by the at least one first boundary,
re-define the second boundary, wherein at least one of the at least one first boundary is provided within the second boundary, and
change the third boundary, whereby the second view of the video recording corresponds to a view of the video recording defined by the third boundary.

15. A method for zooming of a video recording, the method comprising:
detecting at least one object in a first view of the video recording,
tracking the detected at least one object,
selecting at least one of the tracked at least one object,
defining the selected at least one object by at least one first boundary (270),
defining a second boundary (280), wherein at least one of the at least one first boundary is provided within the second boundary, and
defining a third boundary and a second view of the video recording corresponding to a view of the video recording defined by the third boundary,
wherein the method further comprises performing at least one of:
in-zooming of the video recording relative to the first view of the video recording, by changing the third boundary such that the third boundary coincides with the second boundary, whereby the second view of the video recording, played in the size of the first view of the video recording, constitutes the in-zooming of the video recording, or
out-zooming of the video recording relative to the second view of the video recording corresponding to a view of the video recording defined by the third boundary of decreased size relative to the first view of the video recording, by changing the third boundary such that the third boundary coincides with the first view, whereby the second view of the video recording, played in the size of the first view of the video recording, constitutes the out-zooming of the video recording,
wherein the method further comprises, in case at least one predetermined event occurs during the video recording:
stopping a performed at least one of an in-zooming or an out-zooming of the video recording,
tracking the selected at least one object,
re-defining the selected at least one object by the at least one first boundary,
re-defining the second boundary, wherein at least one of the at least one first boundary is provided within the second boundary, and
changing the third boundary, whereby the second view of the video recording corresponds to a view of the video recording defined by the third boundary.

16. A computer-readable storage medium comprising instructions for zooming of a video recording, wherein the instructions, when executed by a processor, cause the processor to carry out a method comprising:
detecting at least one object in a first view of the video recording,
tracking the detected at least one object,
selecting at least one of the tracked at least one object,
defining the selected at least one object by at least one first boundary,
defining a second boundary, wherein at least one of the at least one first boundary is provided within the second boundary, and
defining a third boundary and a second view of the video recording corresponding to a view of the video recording defined by the third boundary,
wherein the method further comprises performing at least one of:
in-zooming of the video recording relative to the first view of the video recording, by changing the third boundary such that the third boundary coincides with the second boundary, whereby the second view of the video recording, played in the size of the first view of the video recording, constitutes the in-zooming of the video recording, or
out-zooming of the video recording relative to the second view of the video recording corresponding to a view of the video recording defined by the third boundary of decreased size relative to the first view of the video recording, by changing the third boundary such that the third boundary coincides with the first view, whereby the second view of the video recording, played in the size of the first view of the video recording, constitutes the out-zooming of the video recording, and
wherein the method further comprises, in case at least one predetermined event occurs during the video recording:
stopping a performed at least one of an in-zooming or an out-zooming of the video recording,
tracking the selected at least one object,
re-defining the selected at least one object by the at least one first boundary,
re-defining the second boundary, wherein at least one of the at least one first boundary is provided within the second boundary, and
changing the third boundary, whereby the second view of the video recording corresponds to a view of the video recording defined by the third boundary.
